(19) United States
(12) Patent Application Publication
(10) Pub. No.: US 2024/0426360 A1
(43) Pub. Date: Dec. 26, 2024

(54) BRAKE PAD WITH A PLASTIC BACKING PLATE

(71) Applicant: RAICAM DRIVELINE S.R.L., Mondovi' (Cuneo) (IT)

(72) Inventors: Sandro BONARDO, Peveragno (Cuneo) (IT); Matteo GIACCARDI, Piozzo (Cuneo) (IT)

(21) Appl. No.: 18/699,740

(22) PCT Filed: Oct. 13, 2022
(86) PCT No.: PCT/EP2022/078494

§ 371 Date: Apr. 9, 2024

(30) Foreign Application Priority Data
Oct. 14, 2021 (IT) 102021000026324

(51) Int. Cl. F16D 69/04; B62L 1/00; F16D 55/228; F16D 65/097

(52) U.S. Cl. CPC F16D 69/0408; F16D 55/228; F16D 65/0979; B62L 1/005

(57) ABSTRACT

Provided is a backing plate for a hydraulic brake of a two-wheeled vehicle that is made of plastic material and has a first face and a second face opposite the first face and defining a thickness therewith. The first face is configured to fixedly carry a layer of friction material. An undercut recess, formed within the thickness of the backing plate, opens on the second face and is configured to receive and retain a corresponding portion of a floating piston for brake actuation.

### TECHNICAL FIELD

The present invention relates to a brake pad with a plastic material backing plate shaped to produce a form coupling between the pad and a piston. In particular, but not exclusively, the brake pad is applicable to two-wheeled vehicles.

### BACKGROUND ART

As known, brake pads are conventionally manufactured with metal backing plates in the shape of a plate having a face on which a layer of friction material is fixedly applied. Brake pads with a backing plate of fiber-reinforced plastic material are also known. See, for example, patent publications JP 2013 057337 A, JP 2012 211675 A, and EP 1006289 A2. Brake with a pads fiber-reinforced plastic backing plate are appreciated for their low weight, high strength and high mouldability.

With many brakes, a pair of brake pads is associated with a spring clip adapted to move the brake pads away from the braking surfaces of the brake disc, when the hydraulic pressure of the braking action ceases; in this way, vibrations and sliding of the brake pads against the faces of the disc are reduced.

U.S. Pat. No. 3,720,293 A and GB 1270364 A each disclose a metal backing plate for a hydraulic brake of a vehicle, the backing plate having two opposite faces: a first face configured to fixedly carry a layer of friction material, and a second face, opposite to the first face. The backing plate has a notch and the friction material provides a groove that forms, together with the backing plate, an undercut recess to receive and retain a coupling head of a piston for brake actuation.

JP 2011 047030 A and EP 2472135 A1 disclose a brake comprising a pad connected to a backing plate of non-plastic material. The backing plate, in turn, is connected to a holder. At one end of the holder is an opening that forms, together with the backing plate, an undercut adapted to accommodate an anchor pin. In particular, the undercut accommodates and retains the head of the anchor pin by means of the coupling between a groove provided on the anchor pin and the undercut formed by the coupling of the holder and backing plate.

JP 2013 057337 A discloses a brake pad with a backing plate made of plastic material reinforced with fibers.

### SUMMARY OF THE INVENTION

It is the object of the present invention to simplify a disc brake by eliminating the conventional spring clip element for the brake pads.

The present invention proposes to keep the brake pads in contact with the pistons as much as possible through mechanical fixing, in order to prevent the brake pads from vibrating and sliding against the disc when the braking action has ceased.

The above and other objects and advantages, which will be better understood hereinafter, are achieved according to the present invention by a backing plate for a brake pad having the features set forth in claim 1. Preferred embodiments of the invention are defined in the dependent claims.

According to an aspect of the present invention, a backing plate for the hydraulic brake of a two-wheeled vehicle, is made of plastic material and has two opposite faces. A first face fixedly carries a layer of friction material. A second face, opposite to the first face, defines a thickness therewith. Formed within the thickness of the backing plate is at least one undercut recess that opens on the second face and is configured to receive and retain a corresponding portion of at least one floating piston for brake actuation.

According to another aspect, the present invention provides an assembly comprising a brake pad and at least one associated actuating floating piston.

According to a further aspect, the present invention provides a brake caliper with a caliper body and at least one assembly comprising a brake pad and at least one floating piston.

### BRIEF DESCRIPTION OF THE DRAWINGS

The features and advantages of the present invention will be evident from the following description, given by way of non-limiting example. Reference is made to the attached drawings, in which:

FIG. 1 is an exploded perspective view of a hydraulic brake according to an embodiment of the invention;

FIG. 2 is a perspective view of a backing plate for a brake pad according to an embodiment of the present invention;

FIG. 3 is an elevation view of a floating piston;

FIG. 4 is a cross-sectional view taken along section plane indicated at A-A in FIG. 1, and showing a form coupling between the brake pad and two floating pistons;

FIG. 5 is an axial cross-sectional view of the hydraulic brake according to a cross-section plane indicated at D-D in FIG. 1.

### DETAILED DESCRIPTION

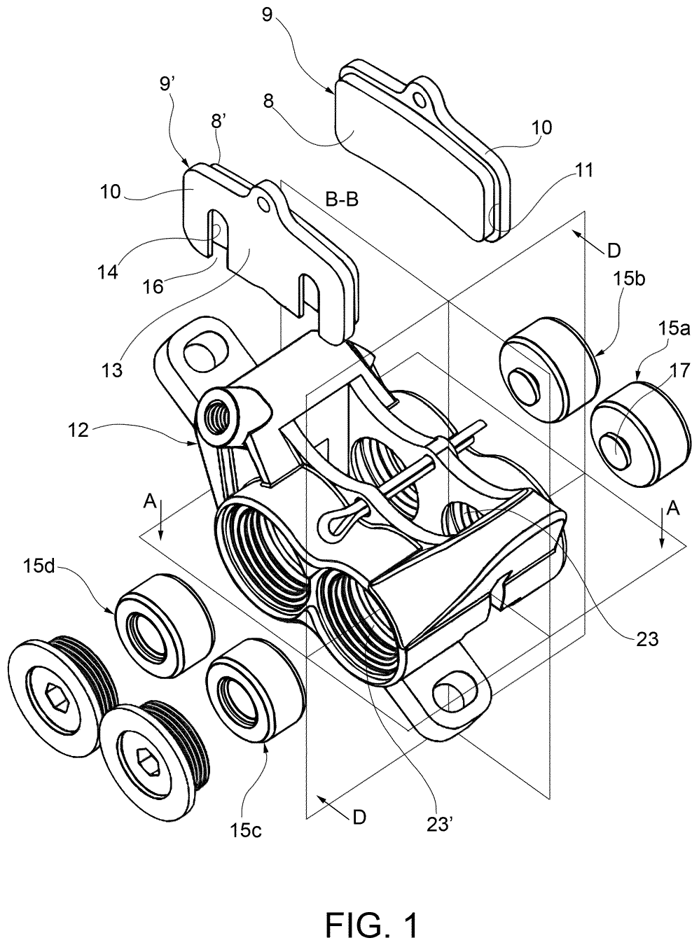

Referring initially to FIG. 1, an embodiment of a hydraulic brake according to the invention will be first described in its normal operational condition. A hydraulic brake, in the example illustrated herein, comprises a per se known caliper body 12, with two brake pads 9, 9′ and four floating pistons 15a, 15b, 15c, 15d.

The caliper body 12 defines a geometric vertical mid-plane, designated at B-B, which is perpendicular to the axis of rotation of the brake disc (not shown). Throughout the present description and in the claims, terms and expressions indicating positions and orientations such as “axial”, “radial”, “longitudinal”, should be construed as referring refer to the central geometric plane B-B.

The floating pistons 15a, 15b, 15c, 15d are accommodated in cylindrical seats 23, 23′ which are formed in the brake caliper body 12 and arranged in pairs on opposite sides of the central plane B-B. The two pairs of cylindrical seats are axially aligned and spaced apart, to accommodate the respective floating pistons, which act in pairs on one side of two brake pads which in use are arranged facing a respective one of the two braking surfaces on opposite faces of a brake disc.

The overall arrangement of the hydraulic brake illustrated in FIG. 1 is to be considered generally known. Consequently, in the following description, only the elements of specific importance and interest for the purposes of implementing the invention will be described in detail.

The brake pads 9, 9′ each comprise a backing plate 10 and a layer of friction material 8, 8′.

The backing plate 10 is made of plastic material, preferably a plastic material with high mechanical strength and high temperature resistance such as: polypropylene (PP), polyamide (6, 66), polyester (PET), polyphthalamide (PPA), polyphenyl sulfide (PPS), petereterketone (PEEK) and the like.

Preferably, the plastic material is reinforced with fibers, for example fiberglass, carbon fiber, aramid fiber, synthetic aramid fiber (Kevlar®). The brake pads 9, 9′ are housed in the caliper body 12 with the respective friction materials facing a central geometric plane B-B. In use, the floating pistons 15a-15d urge the brake pads 9, 9′ in opposite axial directions against the opposite side faces of a brake disc (not shown).

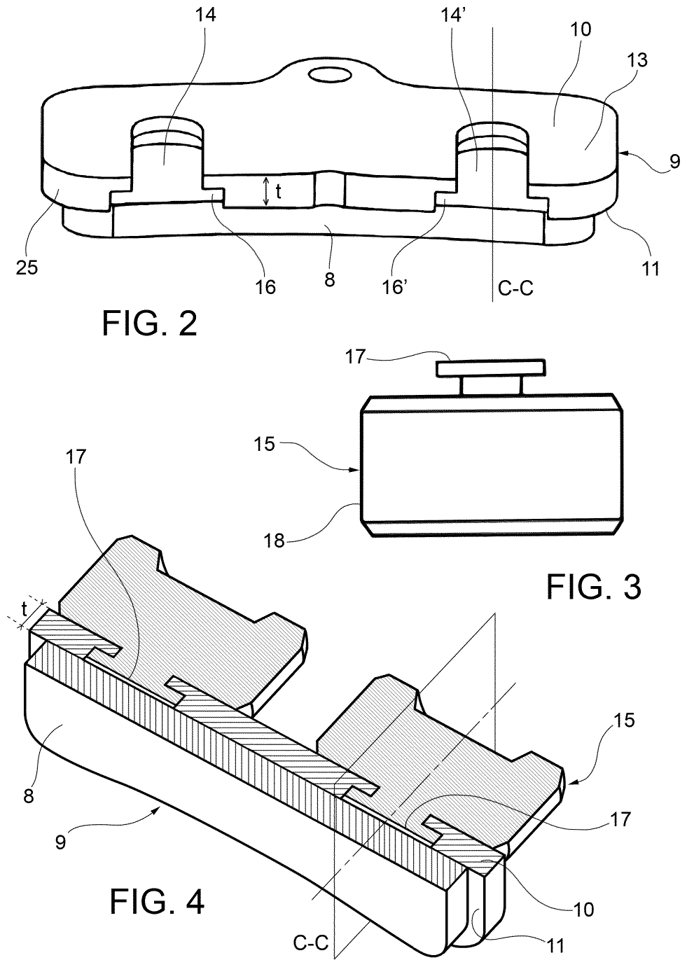

With reference to FIG. 2, the backing plate 10 has two opposite faces, of which a first face 11 configured to fixedly carry (typically by gluing or molding) a layer of friction material 8, 8′, and a second face 13, opposite to the first face. The second face 13 defines a thickness t with the first face 11.

Within the thickness t of the backing plate there is formed at least one undercut recess, in this example two undercut recesses 14, 14′. The or each undercut recess 14, 14′ open(s) on the second face 13 of the backing plate 10 and is/are configured for receiving and retaining a corresponding portion of a respective floating piston 15 that extends to urge the pad against the brake disc when the brake is actuated.

Embodiments may provide that the undercut recess 14, 14′ extends throughout the thickness t of the backing plate 10 (FIG. 2), whereby the recess opens also on the first face 11 of the backing plate.

In the exemplary embodiment shown in FIG. 2, the or each undercut recess 14, 14′ defines a seat advantageously having a symmetrical shape with respect to a vertical plane of symmetry C-C (FIG. 2), perpendicular to the second face 13 of the backing plate 10.

Preferably, the or each undercut recess 14, 14′ has an insertion opening 16, 16′ which opens on a lateral edge 25 of the backing plate 10.

In the embodiment of FIG. 2, the backing plate has two undercut recesses 14, 14′ which are horizontally spaced and configured to receive, through the insertion opening 16, 16′, a portion of a respective floating piston 15, and retain it.

With reference to FIG. 3, the floating piston 15 has a cylindrical lateral surface 18 and an integrated coupling head 17 that protrudes integrally from one face of the piston, with an enlarged end portion having shape and size at least partially corresponding to or matching the shape and size of a respective one of the undercut recess 14, 14′ presented by the backing plate 10.

The coupling head 17 of the floating piston 15 is intended to provide a form coupling between the backing plate 10 of the brake pad 9 and the floating piston 15 (FIG. 4).

Preferably, the coupling head 17 has an axially symmetrical shape corresponding to the shape and size of the undercut recess that receives it. In the exemplary embodiments illustrated herein, the coupling head 17 has a T shape (FIG. 3).

At least one engagement surface 19 facing away from the second surface 13 is formed by the backing plate 10 within the undercut recess 14, 14′. The engagement surface 19 serves as a gripping surface for the coupling head 17 of the piston to pull the brake pad 9, 9′ away from the brake disc when the braking action ceases.

The size of the undercut recess(es) of the backing plate and the coupling head of the floating piston described and illustrated herein is not to be considered as limiting for the implementation of the invention.

Embodiments providing that the undercut recess 14, 14′ extends throughout thickness t of the backing plate 10 (FIG. 2), thereby opening on the first 11 and second 13 faces of the backing plate, facilitate the assembling step in which the coupling head 7 of the floating piston is inserted into the insertion opening 16 of the backing plate.

Preferably, in order to facilitate assembling, some axial clearance may be provided in the assembled condition (FIG. 4) between the coupling head 17 of the floating piston and the layer 8 of friction material.

Advantageously, the layer of friction material 8, 8′ may be manufactured as a solid block, without having to form recesses or grooves within it.

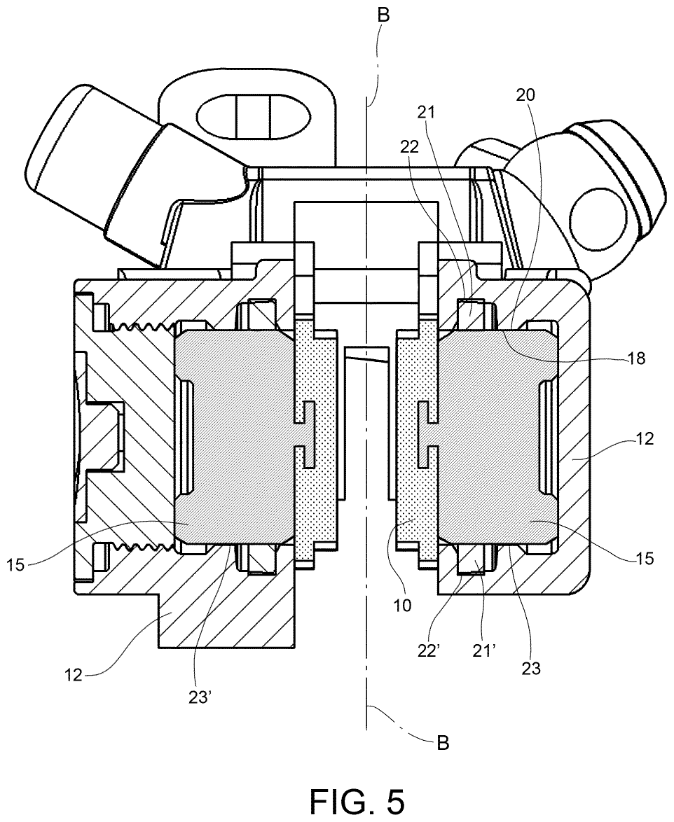

With reference to FIG. 5, the or each floating piston 15 is received in an axially movable manner in a cylindrical seat 23, 23′ of the caliper body 12 so that the cylindrical lateral surface 18 of the piston is substantially coaxially parallel to the internal cylindrical surface 20 of the seat formed by the caliper body 12.

According to an embodiment, the or each floating piston is maintained in said position by at least one annular seal 21, 21′ of elastic material inserted in a circumferential groove 22, 22′ formed by the seat 23, 23′ of the caliper body 12.

Preferably, the annular seal 21, 21′ is sized so as to be radially compressed between the cylindrical lateral surface 18 of the piston and a bottom surface of the groove 22, 22′.

Operation of a preferred embodiment is as follows. When the hydraulic disc brake is actuated, the piston 15 is urged in an axial direction from a starting position, toward the central geometric plane B-B (and toward the brake disc, not shown), thereby elastically deforming the annular seal 21, 21′ which is compressed between the cylindrical lateral surface 18 of the piston 15 and the bottom surface of the groove 22, 22′. At the same time, the piston 15 pushes the brake pad 9 in an axial direction toward one face of the brake disc, to apply a braking torque. When the braking action ends, the elastic annular seal 21, 21′ returns to its initial undeformed condition, taking the piston back to the starting retracted position.

Due to the mechanical form coupling between the coupling head 17 of the piston 15 and the undercut recess 14, 14′ of the backing plate 10, the brake pad is moved away from the disc, i.e. pulled away from it due to the elastic return of the annular seal. In the absence of a braking action, the form coupling keeps the brake pads in contact with the pistons as much as possible, in order to avoid vibrations and sliding of the brake pads against the disc.

While specific embodiments of the invention have been disclosed, it is to be understood that such disclosure has been merely for the purpose of illustration and that the invention is not to be limited in any manner thereby. It will be apparent to those skilled in the art that various modifications can be made without departing from the scope of the invention as defined in the accompanying claims.

What is claimed is:

1. A backing plate of plastic material for a hydraulic brake of a two-wheeled vehicle, the backing plate comprising two opposite faces:
a first face configured to fixedly carry a layer of friction material; and
a second face, opposite to the first face and defining a thickness therewith;
wherein formed within the thickness of the backing plate is at least one undercut recess that opens on the second face and is configured to receive and retain a corresponding portion of at least one floating piston for brake actuation.

2. The backing plate of claim 1, wherein the at least one undercut recess has a symmetrical shape with respect to a plane of symmetry perpendicular to the second face of the backing plate.

3. The backing plate of claim 1, wherein the at least one undercut recess has an insertion opening for the at least one floating piston formed in a lateral edge of the backing plate.

4. The backing plate of claim 1, wherein the plastic material has high mechanical strength and high resistance at high temperature, and wherein the plastic material is selected from the group consisting of: polypropylene (PP), polyamide 6, polyamide 66, polyester (PET), polyphthalamide (PPA), polyphenyl sulfide (PPS), and polyether ether ketone (PEEK).

5. The backing plate of claim 4, wherein the plastic material is reinforced with fibers.

6. The backing plate according to claim 1, wherein said at least one undercut recess extends throughout the thickness of the backing plate, and wherein said at least one undercut recess opens also on the first face of the backing plate.

7. The backing plate of claim 1, wherein at least one engagement surface facing away from the second surface is formed by the backing plate within said at least one undercut recess.

8. An assembly comprising a brake pad and at least one associated floating piston, wherein
the brake pad comprises the backing plate of claim 1, and a layer of friction material arranged on the first face of the backing plate,
the at least one floating piston comprises a cylindrical lateral surface and a coupling head having a shape and a size at least partially corresponding to a shape and a size of the at least one undercut recess on the second face of the backing plate, and wherein
a mechanical form coupling is provided between the brake pad and the floating piston.

9. The assembly of claim 8, wherein the layer of friction material is a solid block without recesses or grooves.

10. A brake caliper comprising:
at least one assembly according to claim 8; and
a caliper body forming at least two cylindrical seats axially aligned and spaced with respect to a central geometric plane and adapted for housing two respective floating pistons, wherein each cylindrical seat has a circumferential groove containing an annular seal of elastic material radially compressed between a bottom surface of the circumferential groove and the cylindrical lateral surface of the respective floating piston;
and wherein the annular seal causes the assembly to move away from the central geometric plane in the absence of braking action.
